(19) United States
(12) Patent Application Publication
(10) Pub. No.: US 2005/0094636 A1
(43) Pub. Date: May 5, 2005

(54) Multi protocol label switching apparatus and method for forwarding IP/label-switched hybrid data

(76) Inventors: Kyeseon Lee, Daejeon-city (KR); Hyeon Park, Daejeon-city (KR); Sun Hee Yang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/933,651

(22) Filed: Sep. 2, 2004

(30) Foreign Application Priority Data
Nov. 5, 2003 (KR) 2003-78127

(51) Int. Cl. H04L 12/28; H04L 12/56

(52) U.S. Cl. 370/389

(57) ABSTRACT

A multi protocol label switching (MPLS) apparatus and method are provided. The first forwarding method is a method of forwarding the packet based on the destination address of the packet, and the second forwarding method is a method of forwarding the packet based on a label. When an error has occurred at an LSP between a node and another node, information indicating that an error has occurred at the LSP is recorded in the forwarding table, and the first or second forwarding method is selected based on what is recorded in an error information field of the forwarding data. Accordingly, it is possible to considerably reduce node/network loads and guarantee the continuity of services provided in the MPLS network even when an error has occurred at an LSP in the MPLS network.

### BACKGROUND OF THE INVENTION

This application claims the priority of Korean Patent Application No. 2003-78127, filed on Nov. 5, 2003, in the Korean Intellectual Property Office, the disclosure of which is incorporated herein in its entirety by reference.

1. Field of the Invention

The present invention relates to a multi-protocol label switching (MPLS)-based packet switching apparatus and method, and more particularly, to a MPLS apparatus and method for guaranteeing continuity of services and reducing network loads.

2. Description of the Related Art

Multi-protocol label switching (MPLS) is a standards-approved technology for speeding up network traffic flows and making it easier to manage networks. MPLS involves setting up a specific path for a given sequence of packets, each of which is identified by a label. Each router searches for an address of a node, to which each of the packets is to be forwarded, by referring to the label of each of the packets, thereby saving the time required for each router to search for the address of the node, to which each of the packet is to be forward. This technology is called multi-protocol label switching rather than, for example, single protocol label switching, because it works with Internet protocol (IP), asynchronous transport mode (ATM) protocol, and frame relay network protocol. MPLS transmits packets mostly on Layer 2 of the OSI standard reference model rather than Layer 3 of the OSI standard reference model. MPLS makes it easier to manage a network for quality of service (QoS) as well as enhances the speed of network traffic flows. Until now, various efforts have been made to establish MPLS networks and provide distinctive MPLS services with a high QoS by using various signaling protocols, such as Label Distribution Protocol (LDP), Constraint-based Routing LDP (CR-LDP), and Resource reSerVation Protocol-Traffic Engineering (RSVP-TE). Additionally, various techniques of setting up Label Switched Paths (LSPs) with different reliabilities for different classes of services, protecting the LSPs, and recovering the LSPs if the LSPs are damaged have been suggested.

The above-described efforts to provide high-quality MPLS network services, however, may increase the number of control messages directed to each node of a network or the network itself and may eventually hinder the network from providing normal services by burdening the network with loads of control work. Conventional MPLS network services need periodic control messages for setting up and maintaining regular LSPs. Thus, in some cases, a conventional MPLS network may not be able to provide data forwarding services due to control plane errors even when continuity of the LSPs is guaranteed, i.e., even when the regular LSPs, which are data paths, are available for transmitting services therealong. In addition, in the case of protecting or recovering the LSPs in order to guarantee the QoS, reliability and continuity of the LSPs, it is necessary to use more complicated operations and to more frequently issue control messages, which results in a considerable increase in the workload of each node of the conventional MPLS network or the conventional MPLS network itself and data traffic loss until the LSPs are recovered.

### SUMMARY OF THE INVENTION

The present invention provides a multi protocol label switching (MPLS) apparatus and method that can reduce node or network loads and guarantee the continuity of services by minimizing transmissions of control messages required for establishing and maintaining label switched paths (LSPs) and transmitting packets using an IP forwarding technique when the LSPs malfunction.

According to an aspect of the present invention, there is provided a method of establishing a label switched path (LSP) in a multi protocol label switching (MPLS) system. The method involves (a) setting an economy class service-forwarding equivalence class (ES-FEC), the ES-FEC supporting both an LSP forwarding method and an IP forwarding; (b) determining whether a packet satisfies the ES-FEC based on a header of the packet; (c) if the packet satisfies the ES-FEC, generating a first path establishment message containing identification data and transmitting the first path establishment message, the identification data being used for identifying the ES-FEC; and (d) establishing an LSP corresponding to the ES-FEC based on a second path establishment message and forming a forwarding table comprising a field designating either the LSP forwarding method or the IP forwarding method depending on whether an error has occurred at the LSP, the second path establishment message being received from nodes of an MPLS network in response to the first path establishment message.

According to another aspect of the present invention, there is provided a method of forwarding a packet in a MPLS system. The method involves (a) if an error has occurred at an LSP between one node to another node, recording information indicating that an error has occurred at the LSP in an error information field of a forwarding table; (b) reading an error information field corresponding to an input packet from the forwarding table; and (c) selecting a first forwarding method, in which the input packet is forwarded based on a label, or a second forwarding method, in which the input packet is forwarded based on a destination address of the input packet, with reference to the error information field read in (b).

According to another aspect of the present invention, there is provided an fault management method for an MPLS system. The falut management method involves (a) if an error has occurred at an LSP between one node and another node transmitting an error recovery sensing message; and (b) if an error recovery message is received in response to the error recovery sensing message, deleting information indicating that an error has occurred at the LSP from an error information field of a forwarding table.

According to another aspect of the present invention, there is provided an MPLS apparatus. The MPLS apparatus includes an ES-FEC setting unit, which sets an economy class service-forwarding equivalence class (ES-FEC), the ES-FEC supporting both an LSP forwarding method and an IP forwarding; a message management unit, which generates a first path establishment message containing identification data and transmits the first path establishment message, if a packet is determined to satisfy the ES-FEC based on a header of the packet; and a forwarding table management unit, which establishes an LSP corresponding to the ES-FEC based on a second path establishment message and forms a forwarding table comprising a field designating either the LSP forwarding method or the IP forwarding method depending on whether an error has occurred at the LSP, the second path establishment message being received from nodes of an MPLS network in response to the first path establishment message.

According to another aspect of the present invention, there is provided an MPLS apparatus. The MPLS apparatus includes an error setting unit, which, if an error has occurred at an LSP, records information indicating that an error has occurred at the LSP in an error information field of a forwarding table and IP-forwards an input packet based on a destination address of the input packet; and an error recovery unit, which transmits an error recovery sensing message if an error has occurred at the LSP, and deletes the information from the error information field of the forwarding table and then LSP-forwards the input packet if it receives an error recovery message in response to the error recovery sensing message.

Accordingly, it is possible to reduce node or network loads and guarantee continuity of services even when some LSPs in a network are blocked.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates forwarding tables according to an exemplary embodiment of the present invention and paths, along which packets are transmitted;

FIGS. 2A and 2B are flowcharts illustrating methods of setting an LSP according to exemplary embodiments of the present invention;

FIG. 3 illustrates forwarding tables according to an exemplary embodiment of the present invention, which are formed when an LSP is blocked, and paths, along which packets are transmitted;

FIG. 4A is a flowchart of a packet forwarding method in a multi protocol label switching (MPLS) apparatus according to an exemplary embodiment of the present invention;

FIG. 4B is a flowchart of an fault management method in the MPLS apparatus according to the exemplary embodiment of the present invention;

FIG. 5 shows various types of data stored in an economy class service (ES)-LSP field of a forwarding table according to an exemplary embodiment of the present invention;

FIG. 6 is a diagram illustrating the structure of a forwarding equivalence class (FEC) type length value (TLV) for an ES-LSP; and

FIGS. 7A and 7B are block diagrams illustrating an MPLS apparatus according to an exemplary embodiment of the present invention.

### DETAILED DESCRIPTION OF THE INVENTION

The present invention will now be described more fully with reference to the accompanying drawings, in which exemplary embodiments of the invention are shown.

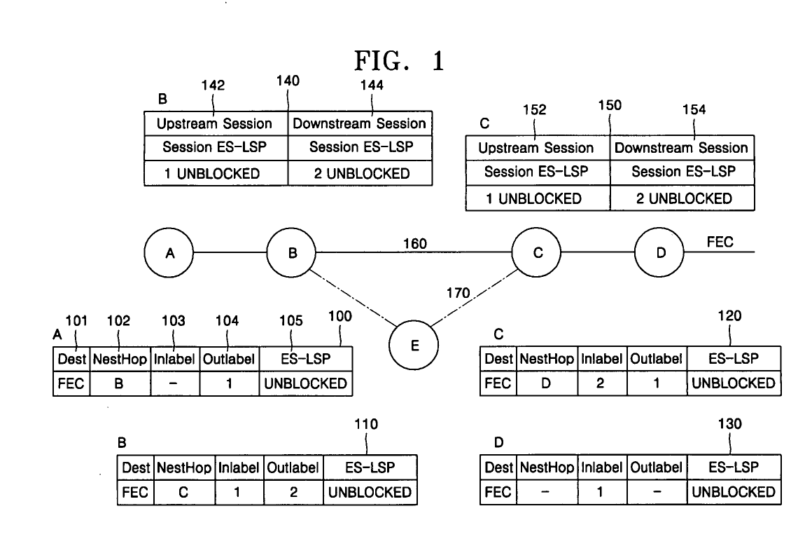

FIG. 1 illustrates forwarding tables according to an exemplary embodiment of the present invention and paths, along which packets are transmitted by referring to the forwarding tables. Referring to FIG. 1, forwarding tables 100, 110, 120, and 130 are provided for nodes A, B, C, and D, and each of the forwarding tables 100, 110, 120, and 130 includes a destination address field 101, a next hop address field 102, an input label field 103, an output label field 104, and an economy class service (ES)-label switched path (LSP) field 105.

The destination address field 101 contains an address of a destination of each packet and the next hop address field 102 contains an address of a next node, to which each packet is transmitted.

The input label field 103 contains an input label, which is included in an input packet and is used for forwarding the input packet in a multi protocol label switching (MPLS) network. Each node searches the input label field 103 of a corresponding forwarding table for the input label and checks the output label field 104 of the corresponding forwarding table, which is provided in association with the input label field 103. The output label field 104 contains an output label that specifies a predetermined node, to which each input packet is to be forwarded. Once each input packet is forwarded to the predetermined node, label information included in the input packet is replaced with the value of the output label field 104.

The ES-LSP field 105 is a field that indicates whether an error has occurred at a Label Switched Path (LSP) in the MPLS network. The LSP may be set up by using a signalling protocol, such as Label Distribution Protocol (LDP, RFC 3036), Constraint-based Routing Label Distribution Protocol (CR-LDP), or Resource reSerVation Protocol-Traffic Engineering (RSVP-TE). If an error has occurred at an LSP, ‘BLOCKED’ is written in the ES-LSP field 105. Otherwise, ‘UNBLOCKED’ is written in the ES-LSP field 105.

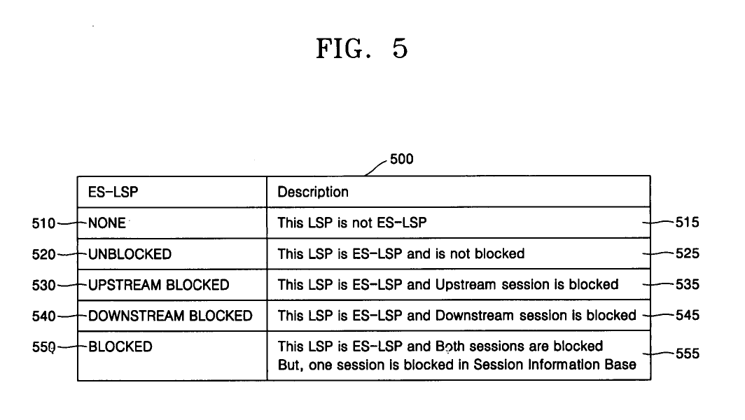

The ES-LSP field 105 is introduced for providing economy-class services. Here, the economy-class services denote services provided while reducing node and/or network loads and guaranteeing service continuity. The ES-LSP field 105 can be divided into two session fields specifying whether an error has occurred at an upstream session or a downstream session of the LSP or both. For example, if an error has occurred at an LSP 160 between the nodes B and C, ‘BLOCKED’ is written in an upstream session field of an ES-LSP field of the forwarding table 110 for the node B, and ‘UNBLOCKED’ is written in a downstream session field of the ES-LSP field of the forwarding table 110 for the node B. The ES-LSP field 105 will be described more fully with reference to FIG. 5.

The nodes A, B, C, and D each include a session table (140 or 150) as well as their respective forwarding tables 100, 110, 120, and 130. The session tables 140 and 150 include upstream session fields 142 and 152, respectively, and downstream session fields 144 and 154, respectively, and store upstream session information, downstream session information, and the frequency of transmitting a control message.

The session table 140 for the node B includes an ES-LSP field in order to support ES-LSPs according to the present invention. The nodes A, B, C, and D periodically transmit a message to one another to check whether LSPs thereamong are blocked. In the case of using LDP, the nodes A, B, C, and D periodically transmit a ‘KeepAlive’ message to one another to check whether the LDPs thereamong are blocked, in which case, the frequency of transmitting the ‘KeepAlive’ message among the nodes A, B, C, and D is stored in the session table for each of the nodes A, B, C, and D. Preferably, but not necessarily, the frequency of transmitting a predetermined control message, such as the ‘KeepAlive’ message, among the nodes A, B, C, and D is set low.

A MPLS apparatus and method according to the present invention maintain connections among nodes even when some of the LSPs provided thereamong are blocked, by performing an IP forwarding process. Therefore, even when the frequency of transmitting a control message among the nodes for sensing whether the LSPs thereamong are blocked is set low, it is possible to guarantee continuity and quality-of-service (QoS) of services.

It is assumed that a path A-B-C-D in FIG. 1 is an ES-LSP. Supposing that the nodes A and D are disposed at edges of the MPLS network, the nodes A and D are an ingress label edge router (LER) and an egress LER, the nodes B and C therebetween are label switched routers (LSR).

An ingress LER determines an LSP, along which a packet received from a non-MPLS network is to be forwarded, by referring to a destination IP address contained in a header of the packet. When a packet with a label is received from an LER, an LSR only checks the label, resets a value of the label of the packet, and forwards the packet to a predetermined outgoing interface. The ingress LER encapsulates a packet according to an outgoing interface (Layer 2) of the packet. An egress LER removes a label from a packet received from an MPLS network and forwards the packet to a predetermined destination specified in the packet. In the MPLS network, the LER, which is a terminal node of an LSP, performs a Layer 3 packet forwarding process, and the LSR, which is an inbetween node of the LSP, performs a Layer 2 forwarding process. Each node in the MPLS network generates a label information table and a forwarding table by using LDP.

If an error has occurred at the LSP 160 between the nodes B and C, ‘BLOCKED’ is written in the ES-LSP field 105 of each of the forwarding tables 110 and 120. The node B searches the forwarding table 120 for an entry corresponding to a packet input thereto and forwards the input packet to a subsequent node by using an MPLS method, if ‘UNBLOCKED’ is written in the ES-LSP field of the searched entry of the forwarding table 110. In other words, the node B switches a label of the input packet with an output label of the forwarding table 110 and then forwards the input packet to the subsequent node.

If ‘BLOCKED’ is written in the ES-LSP field of the searched entry of the forwarding table 110, the node B forwards the input packet to the subsequent node by using an IP forwarding method. Referring back to FIG. 1, the input packet may be IP-forwarded along a path 170 (B-E-C). The node B removes the label of the input packet and then IP-forwards the input packet to the node E by referring to a destination address of the input packet. The node E IP-forwards the packet received from the node B to the node C.

The node C searches the forwarding table 120 for an entry corresponding to the packet received from the node E. The node C adds a label to the received packet and then forwards the received packet to the node D along an LSP therebetween. Accordingly, even though the LSP 160 between the nodes B and C is blocked, it is possible to guarantee of QoS of a service by guaranteeing the continuity of the transmission of the packet from the node A to the node D.

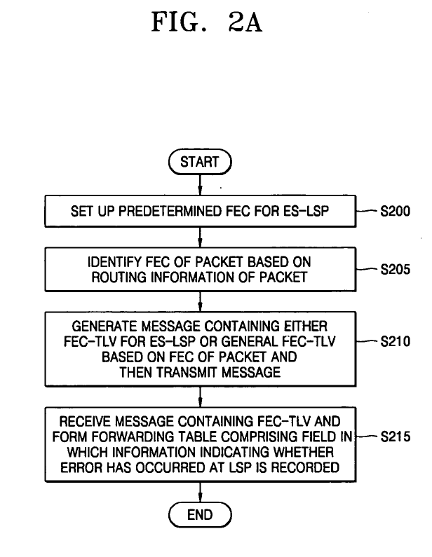

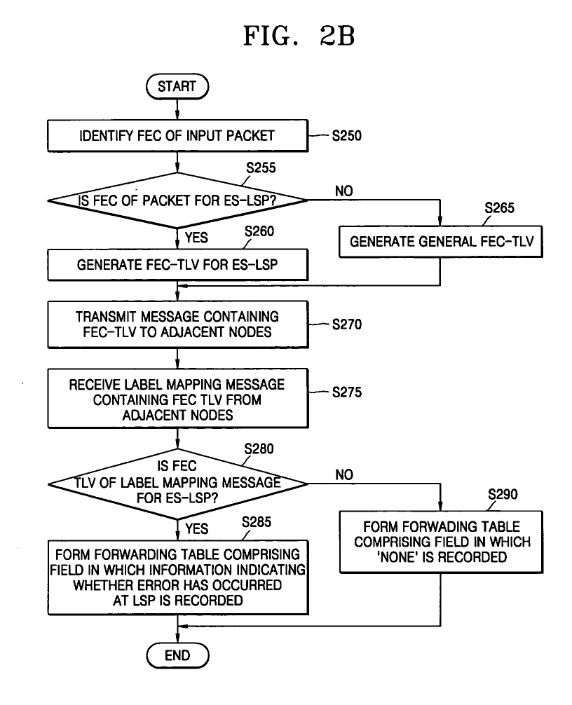

FIGS. 2A and 2B are flowcharts illustrating methods of setting an LSP according to exemplary embodiments of the present invention. Referring to FIGS. 2A and 2B, one of forwarding equivalence classes (FECs) available in an MPLS network is selected for a predetermined service based on a priority level and QoS of the predetermined service in operation S200. In operation S205 or S250, an FEC of an input packet is identified by referring to routing information of the input packet. A node routes the input packet by referring to a destination address of the input packet or a prefix of the input packet, which is as long as a predetermined number of bits. In MPLS, packets are identified by their routing information and are grouped into FECs). In other words, the packets are divided into groups, and an FEC is allotted to each of the groups by using a FEC prefix filtering method, which uses a prefix of a destination address of each of the packets, an FEC host address filtering method, which uses the destination address of each of the packets, and an interface filtering method, which classifies the packets depending on from which ports of nodes the packets are output, i.e., from which output interfaces the packets are output. As described above, an FEC denotes a group of packets that belong to the same service class and thus are forwarded in the same manner. If the FEC of the input packet is a general FEC in operation S255, a general FEC type length value (TLV) is generated in operation S265. If the FEC of the input packet is an FEC for an ES-LSP in operation S255, an FEC TLV for an ES-LSP is generated in operation S210 or S260. Here, a TLV denotes a method of encoding a considerable amount of data contained in a Label Distribution Protocol (LDP, RFC 3036) message. The TLV comprises a type field, a length field, and a value field. The type field specifies the type of the TLV, the length field specifies the length of the TLV, and the value field may contain various contents depending on the type of the TLV. For example, an FEC TLV contains FEC information.

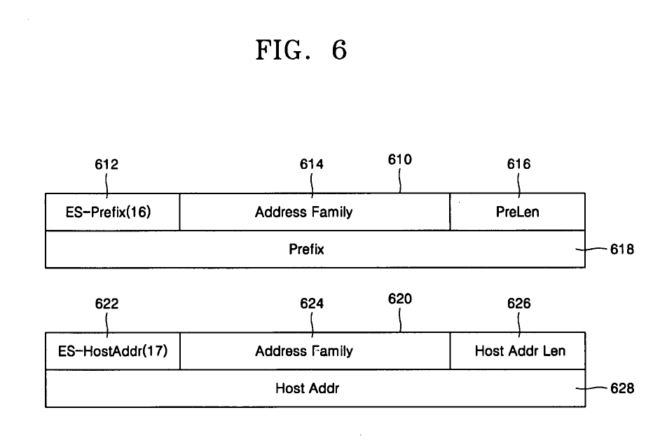

A general FEC TLV and an FEC TLV for an ES LSP according to the present invention have the same data structure. In order to differentiate the FEC TLV for an ES LSP from the general FEC TLV, a specific value is assigned to the FEC TLV for an ES LSP, which will be described more fully with reference to FIG. 6.

The node transmits the general FEC TLV or the FEC TLV for an ES LSP to the outside in operation S215 or S260. The node receives a general FEC TLV or an FEC TLV for an ES LSP in operation S215 or S275. If the node adopts an RFC 3036 downstream-on-demand (DoD) manner, it transmits a label request message to a neighboring node. If the node adopts an RFC 3036 downstream unsolicited (DU) manner, it transmits a label mapping message to the neighboring node. Here, DoD and DU are different types of label distribution manners.

More specifically, DoD distributes a label on a “on demand” basis. Accordingly, a downstream node that receives a label request message sends a label mapping message containing label information to an upstream node. On the other hand, DU distributes a label in an unsolicited manner. Accordingly, once the downstream node recognizes FEC information, it sends the label mapping message to the upstream node.

Various types of messages can be transmitted between the downstream and upstream nodes, and the sequence of the messages transmitted between the downstream and upstream nodes may vary. However, all of the messages transmitted between the downstream and upstream nodes contain either a general FEC TLV or an FEC TLV for an ES LSP.

In operation S280, the node checks whether the received FEC TLV is a general FEC TLV or an FEC TLV for an ES LSP. If the received FEC TLV is an FEC TLV for an ES LSP, the node forms a forwarding table with an LSP field, which specifies whether an LSP is blocked, in operation S215 or S285. If the received FEC TLV is not an FEC TLV for an ES LSP, the node records ‘NONE’ in the LSP field in operation S215 or S290.

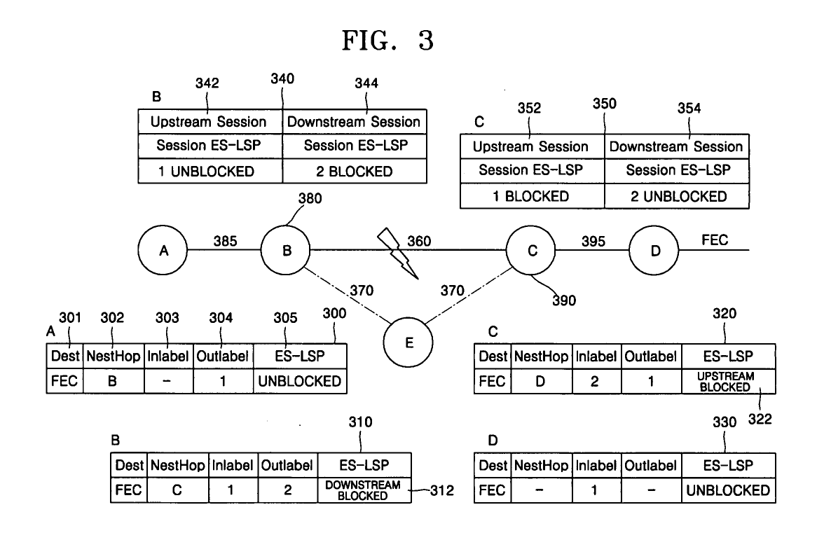

FIG. 3 illustrates forwarding tables according to an exemplary embodiment of the present invention, which are formed when an LSP is blocked, and paths, along which packets are transmitted. Referring to FIG. 3, a path A-B-C-D (360) denotes an LSP, and a path B-E-D (370) denotes an IP forwarding path. The LSP 360 is blocked between nodes B and C.

Session tables 340 and 350 and forwarding tables 300, 310, 320, and 330 are the same as their respective counterparts of FIG. 1, and thus their detailed descriptions will be omitted.

If the LSP 360 is blocked between the nodes B and C, ‘DOWNSTREAM BLOCKED’ is written in an ES-LSP field 312 of the forwarding table 310 for the node B, ‘UPSTREAM BLOCKED’ is written in the ES-LSP field 322 of the forwarding table 320 for the node C, ‘BLOCKED’ is written in a downstream session field of the session table 340 for the node B 380, and ‘BLOCKED’ is written in an upstream session field 352 of the session table 350 for the node C 390.

DOWNSTREAM denotes a downstream session for a packet, and UPSTREAM denotes an upstream session for the packet. BLOCKED denotes that a corresponding section of an LSP is blocked, and UNBLOCKED denotes that the corresponding section of the LSP is unblocked. Accordingly, it is possible to efficiently represent whether each of the upstream and downstream sessions for the packet is blocked, by using any of “BLOCKED” or “UNBLOCKED”, or “DOWNSTREAM BLOCKED” or “UPSTREAM BLOCKED”.

As shown in the session table 340 for the node B, ‘BLOCKED’ is written in the downstream session field 344, but ‘UNBLOCKED’ is written in the upstream session field 342. Accordingly, when the node B receives a packet, it checks the forwarding table 320 and recognizes that a downstream session is blocked. Then, the node B removes a label from the packet and then forwards the packet by using an IP forwarding method rather than a typical LSP method. In other words, the node B forwards the packet to a node E rather than to the node C along the IP forwarding path 370. Then, the node E IP-forwards the packet received from the node B to the node C.

When the node C receives the packet from the node E, the node C checks the forwarding table 310 and recognizes that an upstream session is blocked but a downstream session is unblocked. Thereafter, if the packet received from the node E has been IP-forwarded from the node E, the node C forwards adds a label to the packet and forwards the packet to the node D along the LSP 360. If the node D is an egress LER in an MPLS network, it removes the label from the packet and then IP-forwards the packet to a destination of the packet. In short, the packet is forwarded from the node A to the node B, from the node B to the node E, from the node E to the node C, and from the node C to the node D. In particular, an IP forwarding method is used for forwarding the packet from the node B to the node E and from the node E to the node C, and a typical LSP method is used for forwarding the packet from the node A to the node B and from the node C to the node D.

As described above, if a section of an LSP is erroneous, the section is blocked, and the rest of the LSP is maintained to function normally. Then, packets are forwarded along the LSP bypassing the error-occurred section of the LSP through IP forwarding, thereby guaranteeing continuity of the transmission of the packets.

In the present invention, if an error has occurred at a section of an LSP during a packet forwarding service, nodes in the vicinity of the predetermined session stop operating a ‘KeepAlive’ timer without transmitting a notification message or a label release/withdrawal message according to the RFC 3036. Therefore, the nodes of the error-occurred section only transmit a Hello message indicating that they have sensed recovery of the error-occurred section, and other nodes process packets as if the LSP had never been blocked. In other words, nodes along the entire LSP but the error-occurred section consider the LSP as normal and perform the packet forwarding service in a label switching method, and the nodes of the error-occurred section perform the packet forwarding service in an IP forwarding method until the predetermined section is recovered.

If the error-occurred section is recovered, only the nodes of the error-occurred section recognize the recovery of the error-occurred section and takes advantage of LSP information that could have been abandoned when an error occurred to forward packets in a label switching method in the recovered section.

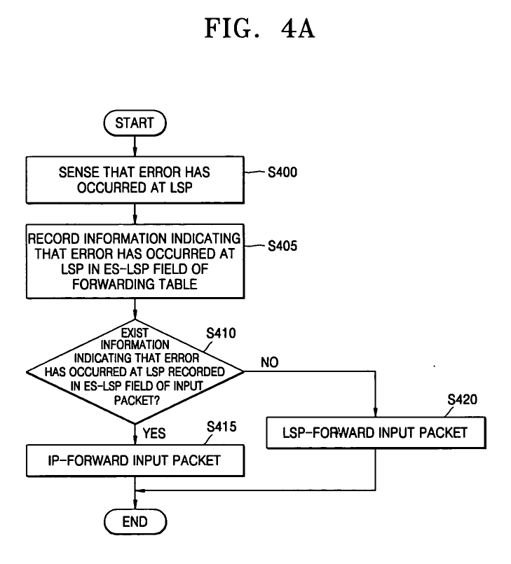

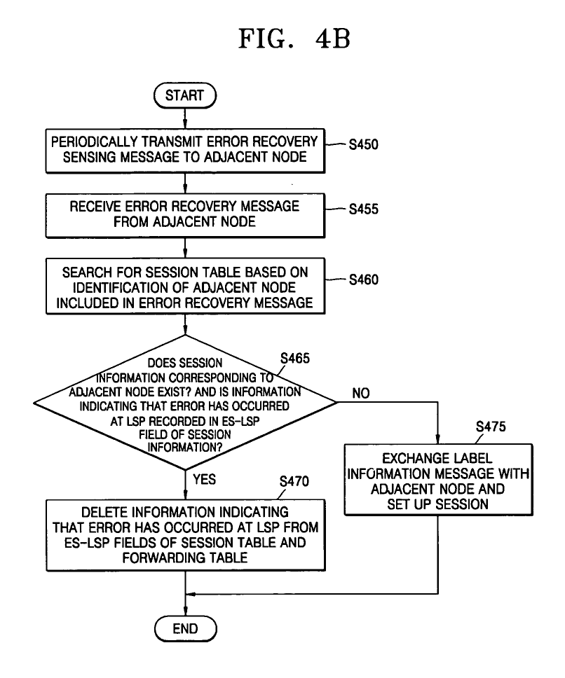

FIG. 4A is a flowchart of a packet forwarding method according to an exemplary embodiment of the present invention. Referring to FIG. 4A, a node senses that an LSP to an adjacent node is blocked in operation S400. Once the node senses the blockage of the LSP to the adjacent node, it records error information indicating the LSP to the adjacent node is blocked in an ES-LSP field of a forwarding table in operation S405. The node differentiates an occasion when an upstream of the LSP to the adjacent node is blocked from an occasion when a downstream of the LSP to the adjacent node is blocked and then records the error information in the ES-LSP field of the forwarding table for each of the two occasions. Recording the error information in the ES-LSP field of the forwarding table will be described more fully later with reference to FIG. 5. When the node receives a packet, it determines whether the error information is recorded in the ES-LSP field of the forwarding table. If the error information is recorded in the ES-LSP field of the forwarding table in operation S410, the node transmits the received packet using an IP forwarding method in operation S415. Otherwise, the node transmits the packet by using an LSP method in operation S420.

FIG. 4B is a flowchart of an fault management method according to an exemplary embodiment of the present invention. Referring to FIG. 4B, a predetermined node transmits an error recovery sensing message to an adjacent node on the LSP in operation S450 if an LSP from the predetermined node to the adjacent node is erroneous. A Hello message defined in the LDP may be used as the error recovery sensing message.

The predetermined node receives an error recovery message from the adjacent node in operation S455 and then performs appropriate processes, e.g., session setting. More specifically, when the predetermined node receives a Hello message, i.e., the error recovery message, from the adjacent node as a response to another Hello message that it has transmitted to the adjacent node, i.e., the error recovery sensing message, it performs appropriate processes, e.g., session setting.

The error recovery sensing message and the error recovery message may be transmitted between the predetermined node and the adjacent node when a daemon, which is a process that runs in the background. The predetermined node searches a session table based on an identifier of the adjacent node contained in the error recovery message in operation S460. The session table stores session information for management of a session for any two nodes, and the interval of transmission of a KeepAlive message.

If an entry corresponding to the error recovery message received from the adjacent node exists in the session table, and “BLOCKED” is recorded in an ES-LSP field of the entry in operation S654, the predetermined node records “UNBLOCKED” in an ES-LSP field of the session table and in an ES-LSP field of a forwarding table. Once the LSP between the predetermined node and the adjacent node is recovered, previously set session information can be used without setting a new session for the predetermined node and the adjacent node. If the entry corresponding to the identifier of the adjacent node does not exist in the session table, the predetermined node sets a session in operation S475 by performing a predetermined message exchange process.

FIG. 5 illustrates various types of data that can be stored in an ES-LSP field 500 of a forwarding table according to an exemplary embodiment of the present invention. Referring to FIG. 5, the ES-LSP field 500 stores data indicating three states, i.e., NONE 510, UNBLOCKED 520, and BLOCKED 550. BLOCKED 550, which is one of the three states, is divided into UNSTREAM BLOCKED 530 and DOWNSTREAM BLOCKED 540. NONE 500 denotes an occasion when a predetermined node on an LSP does not support ES-LSPs according to the present invention but supports a conventional MPLS network, as indicated by 515 of FIG. 5.

UNBLOCKED 520 denotes a normal state, in which an error is yet to occur at the LSP, as indicated by 525 of FIG. 5. BLOCKED 550 denotes an occasion when an error has occurred at the LSP, as indicated by 555 of FIG. 5. UPSTREAM BLOCKED 530 denotes an occasion when an error has occurred in an upstream session, as indicated by 535 of FIG. 5. DOWNSTREAM BLOCKED 540 denotes an occasion when an error has occurred in a downstream session, as indicated by 545 of FIG. 5. All of the above states except NONE 510 support ES-LSPs according to the present invention. States other than those set forth herein may be stored in the ES-LSP field 500 of the forwarding table according to the exemplary embodiment of the present invention.

FIG. 6 is a diagram illustrating the structure of an FEC TLV for an ES LSP according to an exemplary embodiment of the present invention. Referring to FIG. 6, the FEC TLV comprises an FEC element 610, which comprises ES-prefix 612, Address Family 614, PreLen 616, and Prefix 618, and an FEC element 620, which comprises ES-HostAddr 622, Address Family 624, HostAddr Len 626, and HostAddr 628.

ES-Prefix 612 indicates that a packet is classified into one of a plurality of FEC groups based on a prefix of a destination address of the packet and that the FEC of the packet supports the ES-LSP according to the present invention. In order to differentiate the FEC of the packet from other general FECs that do not support the ES-LSP according to the present invention, ES-Prefix 612 generally uses a type value of 0×16. Address Family 614 generally uses values defined in the RFC 1700, and each of the values indicates which address family among IP, IPv6, NSAP, E.163, and so forth an address included in the FEC TLV belongs to.

PreLen 616 specifies the length of Prefix 618. Prefix 618 indicates which class an IP address of a network belongs to. ES-HostADDr 622 indicates that the FEC of the packet can be identified based on a destination host address of the packet and that the FEC of the packet supports the ES-LSP according to the present invention. In order to differentiate the FEC of the packet from the other general FECs that do not support the ES-LSP according to the present invention, ES-HostAddr 622 uses a type value of 0×17. Address Family 624 is the same as Address Family 614. HostAddr Len 626 specifies the length of the host address of the packet. Host Addr 628 specifies the host address of the packet.

As described above with reference to FIGS. 2A and 2B, it is determined whether an input packet is routed based on its prefix or host address, and then the FEC TLV of FIG. 6 is generated based on the determination result.

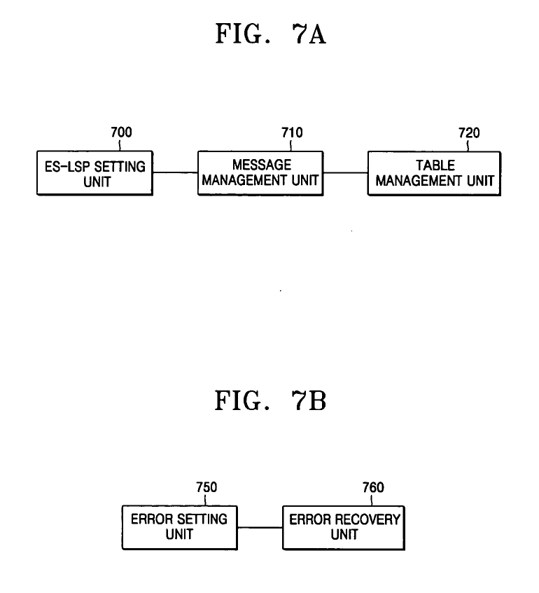

FIG. 7A is a block diagram of an MPLS apparatus according to an exemplary embodiment of the present invention. Referring to FIG. 7A, the MPLS apparatus includes an ES-LSP setting unit 700, a message management unit 710, and a table management unit 720. The ES-LSP setting unit 700 sets an ES-FEC which supports both an LSP forwarding method and an IP forwarding method. In an MPLS method, packets are classified into groups based on their respective FECs and forwards the packets by using labels. The ES-LSP setting unit 700 sets a predetermined FEC that supports the ES-LSP according to the present invention and designates the predetermined FEC to packets.

The message management unit 710 identifies an FEC of an input packet based on a header of the input packet. If the FEC of the input packet is an ES-FEC, a path establishment message containing identification data for identifying the ES-FEC is generated and transmitted. The path establishment message includes label information and is generated as the FEC TLV of FIG. 6. The transmission of the path establishment message is performed following LDP (RFC3036).

The table management unit 720 receives a path establishment message from the outside of the MPLS apparatus and forms a forwarding table which comprises a field specifying whether the LSP forwarding method or the IP forwarding method is to be used to forward the input packet. Whether the input packet is to be forwarded by using the LSP forwarding method or the IP forwarding method is determined based on whether an error has occurred at an LSP, along which the input packet is to be forwarded. The table management unit 720 records predetermined data in the field of the forwarding table so that if an error has occurred at the LSP, the input packet can be IP-forwarded, and once the error is recovered, the input packet can be LSP-forwarded. The type of the predetermined data has already been described above with reference to FIG. 5.

Therefore, once the formation of the forwarding table is completed, and a packet is received, a node searches for a next destination of the packet with reference to the forwarding table and then forwards the packet to the searched destination.

FIG. 7B is a block diagram of an MPLS apparatus according to another exemplary embodiment of the present invention. Referring to FIG. 7B, the MPLS apparatus includes an error setting unit 750 and an error recovery unit 760.

If an error has occurred at an LSP, the error setting unit 750 records information indicating an error has occurred at the LSP in an error information field of a forwarding table and forwards an input packet based on a destination address of the input packet.

The error recovery unit 760 transmits an error recovery sensing message. If the error recovery unit 760 receives an error recovery message in response to the error recovery sensing message, it deletes the error information from the forwarding table and then LSP-forwards the input packet.

The present invention can be realized as a computer-readable code written on a computer-readable recording medium. The computer-readable recording medium includes nearly all kinds of recording devices, on which computer-readable data can be recorded. For example, the computer-readable recording medium includes a ROM, a RAM, a CD-ROM, a magnetic tape, a floppy disk, an optical data storage, and a carrier wave (e.g., data transmission through the Internet). In addition, the computer-readable recording medium can be distributed over a plurality of computer systems connected to a network so that a computer-readable code written thereon can be executed in a decentralized manner.

According to the present invention, when an error has occurred at an LSP, a packet is IP-forwarded. Once the error is recovered, a session is recovered by using existing session information, and then the packet is LSP-forwarded. Therefore, it is possible to guarantee the continuity and QoS of packet services.

In addition, even when an error has occurred at the LSP, it is possible to lengthen the cycle of transmitting a control message to maintain the LSP or detect the error by IP-forwarding the packet. Accordingly, it is possible to considerably reduce network/node loads.

Moreover, nodes adjacent to the LSP, at which an error has occurred, can use an existing session without the need to set up a new session, thus considerably reducing session loads.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of establishing a label switched path (LSP) in a multi protocol label switching (MPLS) system, the method comprising:
(a) setting an economy class service-forwarding equivalence class (ES-FEC), the ES-FEC supporting both an LSP forwarding method and an IP forwarding;
(b) determining whether a packet satisfies the ES-FEC based on a header of the packet;
(c) if the packet satisfies the ES-FEC, generating a first path establishment message containing identification data and transmitting the first path establishment message, the identification data being used for identifying the ES-FEC; and
(d) establishing an LSP corresponding to the ES-FEC based on a second path establishment message and forming a forwarding table comprising a field designating either the LSP forwarding method or the IP forwarding method depending on whether an error has occurred at the LSP, the second path establishment message being received from nodes of an MPLS network in response to the first path establishment message.

2. The method of claim 1, wherein in (d), if an error has occurred at the LSP, error information is recorded in the field of the forwarding table so that the packet can be IP-forwarded.

3. The method of claim 1, wherein the forwarding table comprises:
a first data field, which comprises a destination address of the packet and an output label; and
a second data field, which specifies whether the packet is LSP-forwarded based on the output label or is IP-forwarded based on the destination address of the packet.

4. A method of forwarding a packet in a MPLS system, the method comprising:
(a) if an error has occurred at an LSP between one node to another node, recording information indicating that an error has occurred at the LSP in an error information field of a forwarding table;
(b) reading an error information field corresponding to an input packet from the forwarding table; and
(c) selecting a first forwarding method, in which the input packet is forwarded based on a label, or a second forwarding method, in which the input packet is forwarded based on a destination address of the input packet, with reference to the error information field read in (b).

5. The method of claim 4, wherein in (c), if information indicating that an error has occurred at the LSP is recorded in the error information field of the forwarding table, the second forwarding is selected, and otherwise, the first forwarding method is selected.

6. The method of claim 4, wherein in (a), information indicating that an error has occurred at the LSP is recorded in the error information field of the forwarding table further specifying whether an upstream session or a downstream session of the input packet is erroneous, or both of the upstream and downstream sessions of the input packet are erroneous.

7. The method of claim 4, wherein if the second forwarding method is selected, the input packet is IP-forwarded after removing a label from the input packet.

8. An fault management method for an MPLS system, the fault management method comprising:
(a) if an error has occurred at an LSP between one node and another node transmitting an error recovery sensing message; and
(b) if an error recovery message is received in response to the error recovery sensing message, deleting information indicating that an error has occurred at the LSP from an error information field of a forwarding table.

9. The fault management method of claim 8, wherein if the information indicating that an error has occurred at the LSP is recorded in an error information field of a forwarding table corresponding to an input packet, the input packet is IP-forwarded, and otherwise, the input packet is LSP-forwarded.

10. The fault management method of claim 8 further comprising IP-forwarding an input packet if the information indicating that an error has occurred at the LSP is recorded in an error information field of a forwarding table corresponding to the input packet.

11. An MPLS apparatus comprising:
an ES-FEC setting unit, which sets an economy class service-forwarding equivalence class (ES-FEC), the ES-FEC supporting both an LSP forwarding method and an IP forwarding;
a message management unit, which generates a first path establishment message containing identification data and transmits the first path establishment message, if a packet is determined to satisfy the ES-FEC based on a header of the packet; and
a forwarding table management unit, which establishes an LSP corresponding to the ES-FEC based on a second path establishment message and forms a forwarding table comprising a field designating either the LSP forwarding method or the IP forwarding method depending on whether an error has occurred at the LSP, the second path establishment message being received from nodes of an MPLS network in response to the first path establishment message.

12. The MPLS apparatus of claim 11, wherein the forwarding table management unit records error information in the field of the forwarding table so that the packet can be IP-forwarded when an error has occurred at the LSP corresponding to the ES-FEC.

13. An MPLS apparatus comprising:
an error setting unit, which, if an error has occurred at an LSP, records information indicating that an error has occurred at the LSP in an error information field of a forwarding table and IP-forwards an input packet based on a destination address of the input packet; and
an error recovery unit, which transmits an error recovery sensing message if an error has occurred at the LSP, and deletes the information from the error information field of the forwarding table and then LSP-forwards the input packet if it receives an error recovery message in response to the error recovery sensing message.
